(19) United States
(12) Patent Application Publication
(10) Pub. No.: US 2002/0103853 A1
(43) Pub. Date: Aug. 1, 2002

(54) Method and device for locating a peripheral

(76) Inventors: Larry A. Copp, Boise, ID (US); Matt Howell, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/771,158

(22) Filed: Jan. 26, 2001

(51) Int. Cl. G06F 15/16

(52) U.S. Cl. 709/203; 709/245

(57) ABSTRACT

Methods and apparatus determine the location of a peripheral, such as a multi-function peripheral. One method comprises the steps of receiving a first message at a peripheral server, wherein the message contains a client address; generating a second message containing the address of the peripheral; and sending the second message to the client address. In one embodiment, the peripheral is a printer, the peripheral server is a print queue, and the first message is a print job containing a PML object, such as UI_SELECT_OPTION. The method optionally comprises the step of spooling the print job to the printer. In some embodiments, the second message is a UDP datagram. A second method comprises the steps of sending a first message to the peripheral server, wherein the first message contains an address of the client; and receiving at the client a second message containing the peripheral address. The apparatus comprises a client computer, a peripheral server and a peripheral. The peripheral server is connected to both the client computer and the peripheral. The peripheral server receives a first message from the client computer. The first message contains an address of the client computer. The peripheral receives the first message and notifies the client computer of the peripheral's address. In one embodiment the peripheral directly notifies the client computer of the peripheral's address. In another embodiment, the apparatus also comprises an interface, which is connected between the peripheral server and the peripheral, and the interface generates a message to the client computer. The message notifies the client computer of the peripheral's address. The peripheral server may be a print queue, and the peripheral may be a multi-function peripheral with printer capability.

### FIELD OF THE INVENTION

This invention relates generally to computer network topology determination, and more particularly to locating a peripheral on a computer network.

### BACKGROUND OF THE INVENTION

Printing a document from a client computer to a printer on a computer network is typically done through a print queue (sometimes called “printer queue”). For example, MICROSOFT WINDOWS (™) and other similar operating systems provide print queues to facilitate printing. A print queue on a network is typically shared by several client computers, to provide more economical printing capacity while providing a mechanism to accommodate print jobs that would otherwise conflict by temporally overlapping each other. A print queue is typically provided on a print server, which is one of the computers on the network. Because print queues are so prevalent, application programs (e.g., word processors, spreadsheets, browsers or draw/paint programs) typically send printjobs to a print queue and not the actual printer directly. In fact, when a print queue is utilized, application programs and users need not know—in fact, often do not know—a printer's address.

This is not the case for other types of peripherals. For example, a computer typically utilizes a scanner without an intermediary like a print queue. This raises a challenge when a multi-function peripheral (MFP) is deployed on a network. A multi-function peripheral is one that has two or more peripheral capabilities. Examples of multi-function peripherals are devices that are printers in combination with one or more of a scanner, copier, and facsimile.

Multi-function printers pose a device discovery problem. To utilize the device in its non-printer capacity, a client computer must discover the address of the device. However, the device, as a printer, presents itself to the client computer anonymously through a print queue. Attempts to solve this problem have been less than fully successful. One attempted solution is a two-stage discovery process. In the first stage, the client computer contacts the print queue and determines the type of the printer device (e.g., make and model). In the second stage, the client computer searches for devices of the same type and guesses which of the possible numerous printer devices of that type is the one. This attempted solution suffers from a number of problems. First, it is fraught with ambiguity and produces unreliable results. Second, the searching increases network traffic levels.

### SUMMARY OF THE INVENTION

In one respect, the invention is a method for informing a client of a peripheral address by way of a peripheral server. The method comprises the steps of receiving a first message at a peripheral server, wherein the message contains an address of the client; generating a second message containing the peripheral address; and sending the second message to the address ofthe client. In one embodiment, the peripheral is a printer, the peripheral server is a print queue, and the first message is a print job containing a PML object, such as UI_SELECT_OPTION. (As used herein, the term “print job” refers to information sent to a printer.) The method optionally comprises the step of spooling the print job to the printer. In some embodiments, the second message is a UDP (user datagram protocol) datagram, which has a built-in source field.

In another respect, the invention is a method for a client to discover a peripheral address by way of a peripheral server. The method comprises sending a first message to the peripheral server, wherein the first message contains an address ofthe client; and receiving at the client a second message containing the peripheral address. This method is typically (but not necessarily) performed at the client, whereas the preceding method is typically (but not necessarily) performed at or near the peripheral and/or the peripheral server.

In yet another respect, the invention is an apparatus. The apparatus comprises a client computer, a peripheral server and a peripheral. The peripheral server is connected to both the client computer and the peripheral. The peripheral server receives a first message from the client computer. The first message contains an address of the client computer. The peripheral receives the first message and notifies the client computer of the peripheral's address. In one embodiment, the peripheral directly notifies the client computer of the peripheral's address. In another embodiment, the apparatus also comprises an interface, which is connected between the peripheral server and the peripheral, and the interface generates a message to the client computer. The message notifies the client computer of the peripheral's effective address. The peripheral server may be a printer queue, and the peripheral may be a multi-function peripheral.

In comparison to known prior art, certain embodiments ofthe invention are capable of achieving certain advantages, including some or all of the following: (1) reliably discovering the network address of a peripheral; and (2) eliminating network traffic associated with less reliable discovery techniques. Those skilled in the art will appreciate these and other advantages and benefits of various embodiments ofthe invention upon reading the following detailed description of a preferred embodiment with reference to the below-listed drawings.

### BRIEF DESCRIPTION OF THE DRAWINGS

FIG. 1 is a block diagram of a client computer, peripheral server and peripheral;

FIG. 2 is a block diagram of a client computer, peripheral server, interface and peripheral; and

FIG. 3 is a flowchart of a method according to an embodiment of the invention.

### DETAILED DESCRIPTION OF A PREFERRED EMBODIMENT

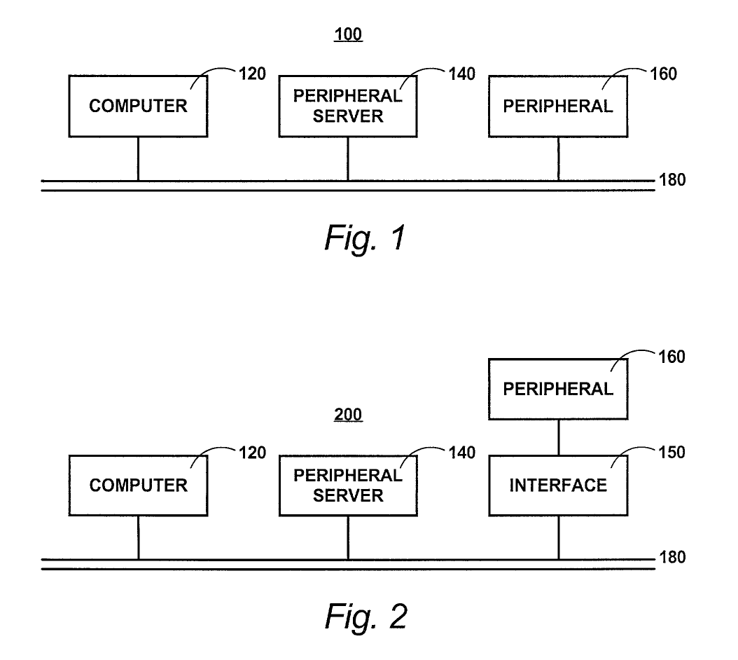

FIG. 1 is a block diagram of a system 100 comprising a client computer 120, a peripheral server 140 and a peripheral 160, all connected on a network 180. The client computer 120 may be any type of computer but is typically a personal computer, such as the type that runs the Microsoft WINDOWS (™) operating system. The peripheral 160 is typically a multi-function peripheral (MFP) with printing capability, and the peripheral server 140 is typically a print server that includes a print queue. The client computer 120, peripheral server 140 and peripheral 160 are each connected to the network 180.

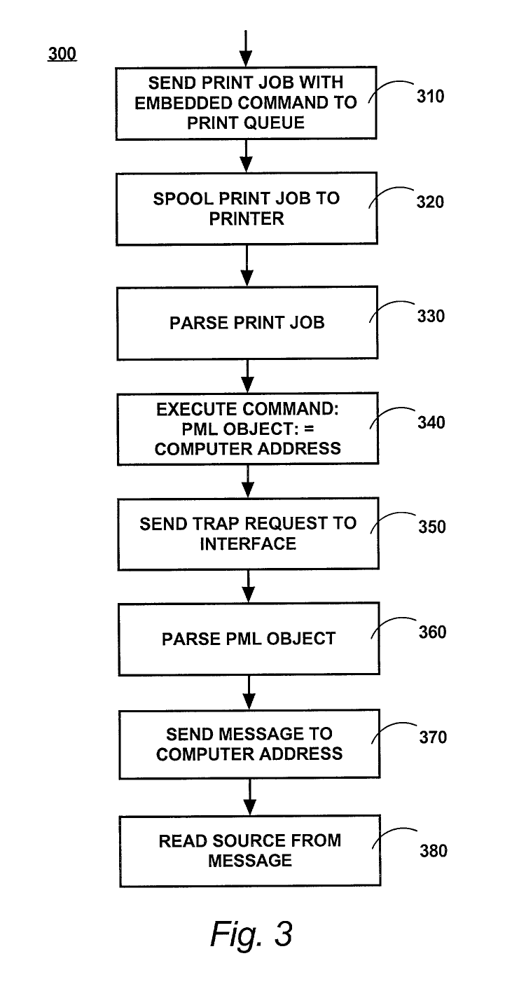

In normal printing operation, a print job is typically transferred via the network 180 from the client computer 120 to the print queue in the peripheral server 140. The print queue in the peripheral server 140 then transfers the print job via the network 180 to the peripheral 160. This two step process is necessary because only the peripheral server 140 is directly visible to the client computer 120. When the client computer 120 must communicate directly with the peripheral 160, such as when the peripheral 160 is used in a non-printing (e.g., scanning) capacity, then the client computer 120 sends a command to the peripheral server 140, telling the peripheral server 140 to instruct the peripheral 160 to inform the client computer 120 of the network address of the peripheral 160. The command from the client computer 120 to the peripheral 140 preferably includes the network address of the client computer 120. The instruction from the peripheral 140 to the peripheral 160 forwards this network address. The command is preferably guised as a printjob; that is, the command is preferably embedded in a print job that does not cause any output. When the peripheral 160 receives the network address of the client computer 120, then the peripheral 160 can send a message to the client computer 120, informing the client computer 120 of the peripheral's (160) address. Details of this method are explained below with reference to FIG. 3.

The system 100 is appropriate when the peripheral 160 itself has a capability to interface with and communicate on the network 180. When the peripheral 160 lacks this capability, an interface 150 is utilized, as shown in the system 200 illustrated in FIG. 2. The interface 150 is a network host for the peripheral 160. Contemporary examples of the interface 150 include the HEWLETT-PACKARD (™) model 170X and 300X JET DIRECT BOXES (™).

FIG. 3 is a flowchart of a method 300 according to an embodiment of the invention. The method 300 is operable with the system 200 (FIG. 2), which includes the interface 150. Those skilled in the art can readily adapt the method 300 for use with the system 100.

The method 300 sends (310) a special print job to a print queue. The print queue receives the special print job. The special printjob is one in which is embedded a command for the printer to set a predetermined variable to be a global address of the of the client computer 120. The special print job contains both the command and the address value. Preferably, the special print job does not contain any printable matter and therefore does not produce any printed output. In the embodiment detailed below, the predetermined variable is a PML (peripheral management language) object, preferably UI_SELECT_OPTION. PML is a protocol for communicating with directly connected (e.g., parallel or USB (universal serial bus) port) devices. PML is similar to SNMP (simple network management protocol), which is used for network connected devices instead. Note that the peripheral 160 in FIG. 2 is connected through a direct connection port, rather than a network connection port; thus, the interface 150 is necessary to host the peripheral 160 on the network 180.

The print queue spools (320) the print job to the destination printer, just as it would with any print job. The printer then parses (330) the print job, as it would any print job. However, when this special printjob is parsed (330), the command is found. The printer then executes (340) the command, setting the PML object to be the supplied computer address. After execution of the command, the printer sends (350) a trap request to the interface, prompting the interface to parse (360) the PML object and to send (370) a message to the specified computer address. The client computer at that address receives the message. In one embodiment, the message is a UDP datagram. The computer receives the message and reads (380) it in order to determine the source of the message. In the case of a UDP datagram, the source address is embedded in the message, as a matter of protocol. In other forms, the source address could be included in the body of the message, if necessary. After completion of the method 300, the computer 120 knows the network address of the peripheral 160.

If the peripheral 160 has a direct network connection and ability to communicate on the network 180 directly, then the method 300 can be simplified. In particular, the parsing, executing, sending and parsing steps 330-360 can be simplified. These steps can be replaced with a simple step of directly executing the command to form a message to send to the computer address.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. A method for informing a client of a peripheral address, by way of a peripheral server, the method comprising:
receiving a first message at the peripheral server, wherein the first message contains an address of the client;
generating a second message containing the peripheral address; and
sending the second message to the client address.

2. The method of claim 1 wherein the peripheral is a printer, and the peripheral server is a print server comprising a print queue.

3. The method of claim 1 wherein the first message is a print job.

4. The method of claim 3 further comprising:
spooling the print job to the printer.

5. The method of claim 3 wherein the print job contains a PML object.

6. The method of claim 5 wherein the generating step comprises:
parsing the printjob;
setting the PML object to contain the address of the client;
sending a trap request to an interface device;
receiving the trap request at the interface device; and
parsing the PML object to find the address of the client.

7. The method of claim 5 wherein the PML object is UI_SELECT_OPTION.

8. The method of claim 1 wherein the second message is a UDP datagram.

9. The method of claim 1 wherein the second message is generated directly by the peripheral.

10. The method of claim 1 wherein the second message is generated by an interface device, wherein the interface device is connected between the peripheral server and peripheral.

11. The method of claim 1 further comprising:
forwarding the first message to the peripheral, wherein the peripheral is connected to the peripheral server.

12. The method of claim 1 wherein the peripheral is a multi-function peripheral.

13. The method of claim 1 wherein the multi-function peripheral comprises at least two capabilities selected from the group consisting of printing, scanning, copying and facsimile.

14. A method for a client to discover a peripheral address, by way of a peripheral server, the method comprising:
sending a first message to the peripheral server, wherein the first message contains an address of the client; and
receiving at the client a second message containing the peripheral address.

15. The method of claim 14 wherein the peripheral is a printer, the peripheral server is a print server comprising a print queue, and the first message is a print job.

16. An apparatus comprising:
a client computer;
a peripheral server, connected to the client computer, wherein the peripheral server receives a first message from the client computer, the first message containing an address of the client computer; and
a peripheral, connected to the peripheral server, wherein the peripheral receives the first message and notifies the client computer of the peripheral's address.

17. The apparatus of claim 16 further comprising:
an interface, connected between the peripheral server and the peripheral, wherein the interface generates a message to the client computer, the message notifying the client computer of the peripheral's address.

18. The apparatus of claim 16 wherein the peripheral server comprises a print queue.

19. The apparatus of claim 16 wherein the peripheral is a multi-function peripheral.

20. The method of claim 19 wherein the multi-function peripheral comprises at least two capabilities selected from the group consisting of printing, scanning, copying and facsimile.
